(19) United States
(12) Patent Application Publication
(10) Pub. No.: US 2026/0101214 A1
(43) Pub. Date: Apr. 9, 2026

(54) AI/ML MODEL SELECTION CRITERIA FOR MEASUREMENT PROCEDURE

(71) Applicant: Telefonaktiebolaget LM Ericsson (publ), Stockholm (SE)

(72) Inventors: Muhammad Ali KAZMI, Sundbyberg (SE); Deep SHRESTHA, Linkoping (SE); Henrik RYDÉN, Stockholm (SE); Thomas CHAPMAN, Solna (SE); Venkatarao GONUGUNTLA, Sundbyberg (SE); Kamel TOURKI, Clamart (FR)

(21) Appl. No.: 19/474,102

(22) PCT Filed: Apr. 10, 2024
(86) PCT No.: PCT/IB2024/053516

§ 371 Date: Oct. 9, 2025

Related U.S. Application Data
(60) Provisional application No. 63/458,324, filed on Apr. 10, 2023.

(51) Int. Cl. H04W 24/08; H04B 7/06; H04L 41/16

(52) U.S. Cl. CPC H04W 24/08; H04B 7/0626; H04L 41/16

(57) ABSTRACT

Methods and systems are described for AI and/or ML model selection in a telecommunications network. One example embodiment includes obtaining a first set of one or more criteria for selecting between at least two AI/ML models; performing at least one measurement procedure to obtain one or more measurements; and using the obtained one or more measurements and the first set of one or more criteria to select between the at least two AI/ML models. A measurement procedure can comprise e.g. CSI, radio link procedure (RLP), positioning measurement, measurement related to cell change procedure etc. Certain described embodiments enhance measurement performance of the measurement (e.g., CQI) and correspondingly improve the outcome/performance of the procedure (e.g., data scheduling) using the measurement. This in turn reduces the overall processing in the UE, frees up at least part of the memory resources and reduces the UE power consumption.

### CROSS REFERENCE TO RELATED INFORMATION

This application claims the benefit of United States of America priority application No. 63/458,324 filed on Apr. 10, 2023, titled “AI/ML model selection criteria for measurement procedure.”

### TECHNICAL FIELD

The present disclosure generally relates to systems and methods for using an AI/ML model for one or more radio network operations.

### BACKGROUND

### AI/ML Modeling and Associated Principles

Artificial intelligence (AI) or machine learning (ML) technique comprises of one or more algorithms, which use a set of data as input for training one or more AI/ML models. The output of the AI/ML model is used by the device (e.g., user equipment (UE), base station (BS) or another node) for performing certain operations or taking certain decisions (e.g., handover etc.) fully or partially based on the prediction, which in turn depends on the trained model. The AI/ML model can be trained in the device online (or on-fly while processing the data) or offline in the background. Online training is an AI/ML training process where the model being used for inference is (typically continuously) trained in (near) real-time with the arrival of new training samples or data. Offline training is an AI/ML training process where the model is trained based on collected samples or data, and where the trained model is later used or delivered for inference.

AI/ML model inference refers to a process of using a trained AI/ML model to produce a set of outputs based on a set of inputs. The AL/ML models can be trained in a device, which can be a UE, a network node or another node. In this respect the AI/ML modes can be broadly classified as:
UE-side (AI/ML) model: a model whose inference is performed entirely at the UE.
Network-side (AI/ML) model: a model whose inference is performed entirely at the network.
One-sided (AI/ML) model: a UE-side (AI/ML) model or a Network-side (AI/ML) model.
Two-sided (AI/ML) model: a paired AI/ML model(s) over which joint inference is performed, where joint inference comprises AI/ML Inference whose inference is performed jointly across the UE and the network, i.e., the first part of inference is firstly performed by UE and then the remaining part is performed by gNB, or vice versa.

An AI/ML model can be transferred or delivered over the air interface either in terms of one or more parameters of a model structure known at the receiving end or a new model with parameters. The model delivery may contain a full model or a partial model.

An example of the AI/ML model training pipeline illustrating different stages is shown in FIG. 1. The term lifecycle management (LCM) of an AI/ML model refers to the process of developing, deploying and maintaining the AI/ML model. An AI/ML model training pipeline includes several processing stages as gathering unprocessed input data from data repositories (data ingestion), finding high-quality input features (data pre-processing), finding the optimal mapping of the model input features to a desired model output target in a sense determined by a loss function (model training), evaluate model performance on unseen data from a functional level as well as from a system level when relevant (model evaluation). The training pipeline typically ends with a model registration stage, which may comprise of operations to make the ML model runnable via compilation to a specific HW (hardware) and of steps like versioning and packaging of the model so that it can be executed.

### Examples of Measurement Procedures

Some non-limiting examples of the measurement procedures performed by the UE and considered in the present disclosure are described below. Examples are Channel State Information (CSI); Radio Link Procedure (RLP); Positioning Measurement Procedure (PMP); and Cell Change Procedure (CCP).

CSI: Examples of CSI are channel quality indicator (CQI), rank indicator (RI), pre-coding matrix indicator (PMI), L1-RSRP (Layer 1-Reference Signal Received Power), etc. The CSI is estimated by the UE based on a reference signal (RS) (e.g., synchronization signal block (SSB), CSI-RS, demodulation reference signal (DMRS), etc.) transmitted by the serving cell. The UE further transmits the estimated CSI to the serving cell. They are used by the serving cell for resource allocation/scheduling or mobility procedures etc. The reported CQI indicates certain transport format (e.g., modulation and coding scheme (MCS)) which can be used for the scheduling of the downlink (DL) data e.g., physical DL shared channel (PDSCH).

RLP: The RLP comprises of one or more measurements performed by the UE to monitor the radio link quality of a serving cell e.g. on reference signal (RS) transmitted by the serving cell. The purpose of the RLP is to ensure that the UE maintains acceptable serving cell's link quality in order to allow the UE to receive DL channels (e.g. physical DL control channel (PDCCH), PDSCH) etc. Examples of the RLP are radio link monitoring (RLM), link recovery procedure (LRP) etc. The LRP is also called a beam management (BM) procedure. Examples of measurements for RLM are radio link quality (e.g. signal to noise ratio (SNR), signal to interference plus noise ratio (SINR), etc.) estimated by the UE on the serving cell for out-of-sync (OOS) detection, in-sync (IS) detection, radio link failure detection etc. Examples of measurements for LRP are radio link quality (e.g., SNR, SINR etc.) estimated by the UE on the serving cell for beam failure detection (BFD), candidate beam detection (CBD), beam failure recovery (BFR) procedure etc.

PMP: The PMP comprises performing one or more positioning measurements on DL RS (e.g., positioning reference signal (PRS)) and/or uplink (UL) RS (e.g., sounding reference signal (SRS)) transmitted between the UE and one or more cells. The cell may also be called a transmission reception point (TRP) or node. Examples of the positioning measurements performed on DL and/or UL signals are RSTD, PRS-RSRP, PRS-RSRPP, UE Rx-Tx time difference, round trip time (RTT), time of arrival (TOA), channel impulse response (CIR), timing advance (TA), angle of departure (AoD), angle of arrival (AoA), power delay profile (PDP), delay profile (DP) etc. The PDP measurement is performed by UE by using reference signal such as PRS. The PDP measurement based on DL PRS signal provides information on delay and power of every path in a multipath environment through which a reference signal such as PRS is received by the UE. In a Line of Sight (Los) environment PDP may contain only one peak where amplitude of the peak can be used to determine power of the LoS path and the associated delay can be used to determine the distance between a UE and the TRP transmitting a reference signal such as PRS. In a multipath environment PDP may contain more than one peak where the amplitude of each peak can be used to determine power of the associated path and the associated delay can be used to determine the time taken by the reference signal transmitted from a TRP to reach the UE through the path. An example of PDP is shown in FIG. 2. An AI/ML model can be trained to predict the UE location based on the PDP measurement. The DP measurement is performed by the UE by using reference signal such as PRS. In contrast to PDP, the DP based on DL PRS signal provides only delay information related to every path in a multipath environment through which a reference signal such as PRS is received by the UE. In a Line of Sight (Los) environment the DP may contain only one peak where delay can be used to determine the distance between the UE and the TRP transmitting a reference signal such as PRS. In a multipath environment the DP may contain more than one delay that can be used to determine the time taken by the reference signal transmitted from a TRP to reach the UE through the path. An example of the DP is shown in FIG. 3. An AI/ML model can be trained to predict the UE location based on the DP. The UE is configured to perform positioning measurements by receiving assistance data (e.g., PRS configuration, type of positioning measurements etc) from a positioning node (e.g., location server, LMF, etc.). The positioning measurement may also be performed by the UE on the sidelink (SL) e.g., on the SL-PRS transmitted between the target UE and one or more assisting or anchor UEs. The UE performing the positioning measurement is called as a target UE and the UE(s) assisting the target UE to perform the SL positioning measurements is called as the anchor or assisting UE.

CCP: The UE performs one or more measurements on DL RS (e.g. SSB, CSI-RS, etc.) of one or more cells for the purpose of the cell change procedures e.g. before the cell change, during the cell change and after the cell change. Examples of the measurements related to the CCP are cell search/identification, signal strength (e.g. RSRP, etc.), signal quality (e.g. RSRQ, SINR, etc.), acquisition of the reference signal index (e.g. SSB index), cell global ID (CGI) acquisition etc. Examples of the CCP are cell selection, cell reselection, RRC connection release with redirection, RRC connection re-establishment, handover, secondary cell (SCell) change, primary secondary cell (PSCell) change etc.

There currently exist certain challenges. The measurements obtained by the UE based on the AI/ML models (i.e., output of the model) reduces the UE power consumption and inefficiently uses the UE resources (e.g., processing resources). However, the measurements obtained by the UE based on the AI/ML models are a kind of prediction. They are reliable if the model used for the measurement is consistent with the environment in which it was trained and developed. However, different AI/ML models are typically trained for different types of radio environment (e.g., radio channel characteristics such as Doppler speed, multipath delay etc.), network deployment scenario (e.g., indoor, local area, macro cell etc.) etc.

### SUMMARY

One embodiment under the present disclosure comprises a method performed by a UE for using an AI/ML model for one or more radio network operations. The method includes obtaining a first set of one or more criteria for selecting between at least two AI/ML models; performing at least one measurement procedure to obtain one or more measurements; and using the obtained one or more measurements and the first set of one or more criteria to select between the at least two AI/ML models.

Another embodiment under the present disclosure comprises a method performed by a network node for configuring a UE for using an AI/ML model, for one or more measurement procedures. The method comprises obtaining a first set of one or more criteria which can be used by the UE for selecting between at least two AI/ML models for performing for one or more measurement procedures; and transmitting information about the obtained first set of one or more criteria to the UE.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates an example of the AI/ML model training pipeline;

FIG. 2 illustrates an example of power delay profile;

FIG. 3 illustrates an example of delay profile;

FIG. 4 illustrates a flow-chart of a method embodiment under the present disclosure;

FIG. 5 illustrates a flow-chart of a method embodiment under the present disclosure;

FIG. 6 illustrates an example of the AI/ML model collecting data and making prediction in tandem manner;

FIG. 7 shows a schematic of a communication system embodiment under the present disclosure;

FIG. 8 shows a schematic of a user equipment embodiment under the present disclosure;

FIG. 9 shows a schematic of a network node embodiment under the present disclosure;

FIG. 10 shows a schematic of a host embodiment under the present disclosure;

FIG. 11 shows a schematic of a virtualization environment embodiment under the present disclosure; and

FIG. 12 shows a schematic representation of an embodiment of communication amongst nodes, hosts, and user equipment under the present disclosure.

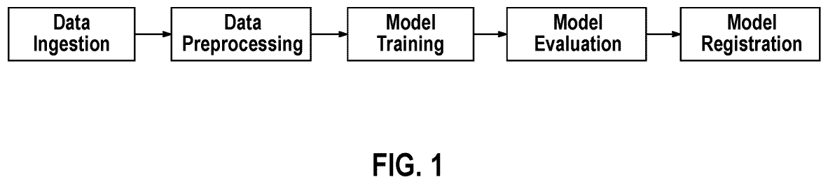

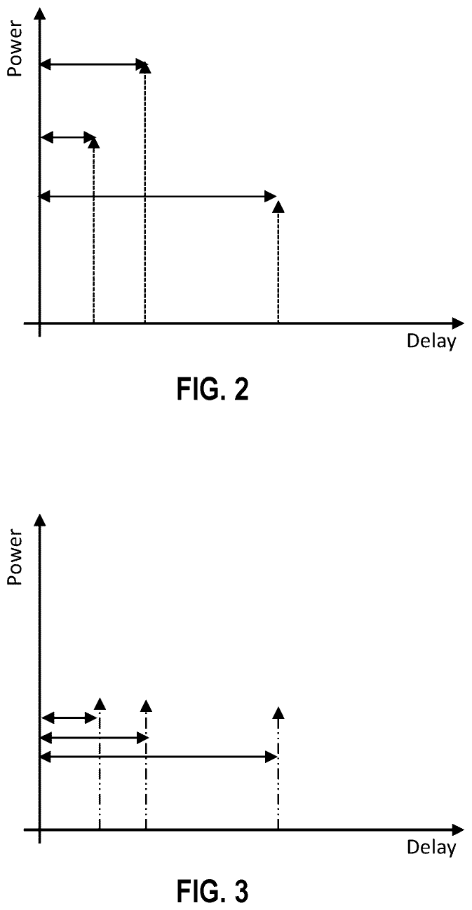

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

Some of the embodiments contemplated herein will now be described more fully with reference to the accompanying drawings. Embodiments are provided by way of example to convey the scope of the subject matter to those skilled in the art. Additional information may also be found in the documents provided in the Appendix.

For purposes of the current disclosure a term node is used which can be a network node or a UE. Examples of network nodes are NodeB, base station (BS), multi-standard radio (MSR) radio node such as MSR BS, eNodeB, gNodeB. MeNB, SeNB, integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, RRU, RRH, nodes in distributed antenna system (DAS), core network node (e.g. MSC, MME etc), O&M, OSS, SON, positioning node (e.g. E-SMLC), etc. Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, Tablet, mobile terminals, smart phone, laptop embedded equipment (LEE), laptop mounted equipment (LME), USB dongles etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP etc. The term radio access technology, or RAT, may refer to any RAT e.g., UTRA, E-UTRA, narrow band internet of things (NB-IoT), WiFi, Bluetooth, next generation RAT, New Radio (NR), 4G, 5G, etc. Any of the equipment denoted by the terms node, network node, or radio network node may be capable of supporting a single or multiple RATs.

The term signal used herein can be any physical signal or physical channel. Examples of physical signals are reference signal such as PSS, SSS, CSI-RS, DMRS, signals in SSB, CRS, PRS, SRS etc. The term physical channel used herein is also called as ‘channel’, which contains higher layer information e.g., logical channel, transport channel etc. Examples of physical channels are MIB, PSBCH, PSCCH, PSSCH, PBCH, PDCCH, PDSCH, PUSCH, PUCCH etc.

The term time resource used herein may correspond to any type of physical resource or radio resource expressed in terms of length of time. Examples of time resources are: symbol, time slot, subframe, radio frame, TTI, interleaving time, etc. The term TTI used herein may correspond to any time period over which a physical channel can be encoded and optionally interleaved for transmission. The physical channel is decoded by the receiver over the same time period over which it was encoded. The TTI may also interchangeably called as short TTI (sTTI), transmission time, slot, sub-slot, mini-slot, mini-subframe etc. The term time-frequency resource used herein for any radio resource defined in any time-frequency resource grid in a cell. Examples of time-frequency resource are resource block, subcarrier, resource block (RB) etc. The RB may also be interchangeably called as physical RB (PRB), virtual RB (VRB) etc.

There currently exist certain challenges in the prior art, as described above. Different AI/ML models are typically trained for different types of radio environment (e.g., radio channel characteristics such as Doppler speed, multipath delay etc.), network deployment scenario (e.g., indoor, local area, macro cell etc.) etc. Therefore, to ensure consistent and reliable measurement results, it is important that the UE applies the appropriate and relevant AI/ML model for performing the prediction-based measurements. Otherwise, the procedures (e.g., data scheduling, beam management, positioning, cell change, etc.) relying on the AL/ML prediction-based measurements will underperform or even fail. This will lead to worse performance than the legacy measurement procedure which relies on real time/actual measurement performed by the UE. Therefore, new rules and UE measurement behaviour need to be defined to ensure that the UE uses the relevant AI/ML model. Certain aspects of the disclosure and their embodiments may provide solutions to these or other challenges.

Certain embodiments may provide one or more of the following technical advantages. Certain described embodiments enhance measurement performance of the measurement (e.g., CQI) and correspondingly improve the outcome/performance of the procedure (e.g., data scheduling) using the measurement. Certain embodiments enable the UE to use the most appropriate model (AI/ML model or the measurement model) under the given scenario/situation. This in turn reduces the overall processing in the UE, frees up at least part of the memory resources and reduces the UE power consumption.

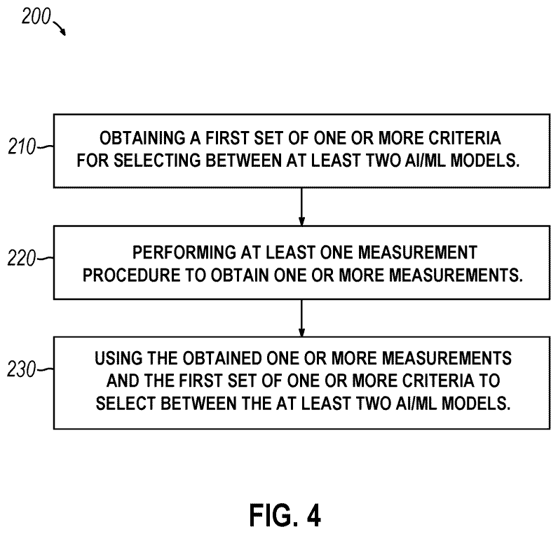

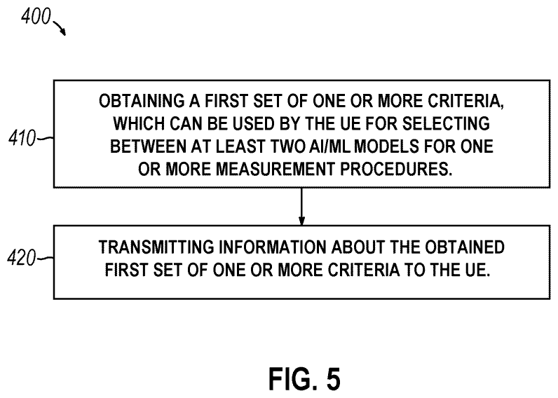

Embodiments under the present disclosure include methods both in a UE and in a network node (e.g. BS, gNB). Several possible embodiments of UE (FIG. 4) and node (FIG. 5) methods are described below.

One UE-based embodiment method 200 under the present disclosure is shown in FIG. 4. Method 200 is a method performed by a UE for using an AI/ML model for one or more radio network operations. Step 210 is obtaining a first set of one or more criteria for selecting between at least two AI/ML models. Step 220 is performing at least one measurement procedure to obtain one or more measurements. Step 230 is using the obtained one or more measurements and the first set of one or more criteria to select between the at least two AI/ML models. Method 200 can comprise a variety of additional or alternative steps. For example, one further optional step can be performing the one or more radio network operations with the selected AI/ML model. Example of radio network operations can include e.g. measurement procedures e.g. CSI, radio link procedure (RLP), positioning measurement, measurement related to cell change procedure etc. A measurement performed by the UE based on an AI/ML model can mean the UE infers or predicts the measurement (i.e. measurement result) based on the output of the AI/ML model. The UE can further obtain a second set of one or more criteria for switching between at least one AI/ML model and a measurement model (e.g. another AI/ML model) for performing measurement procedures. The UE can then use the obtained one or more criteria for switching between the at least one AI/ML model and the measurement model. The UE can further use the selected AI/ML model or the measurement model for performing the at least one measurement procedure. A measurement performed by the UE based on a measurement model can mean the UE performs the measurement (i.e. measurement result) by obtaining one or more measurement samples or snapshots on the signals transmitted between the UE and a cell (e.g. serving cell) e.g. without using the AI/ML model. The obtained one or more samples/snapshots can be combined by the UE based on a function (e.g. average, sum, product, ceiling, floor, xth percentile, etc) to obtain the final measurement results. In one example, the at least two AI/ML models can differ in terms of the radio environment for which they have been trained. For example, the UE based on one of the first set of criteria (e.g., if number of NACKs (non-acknowledgement) for PDSCH (Physical Downlink Shared Channel) reception exceeds certain threshold) selects more robust AI/ML model for performing the CSI measurement (e.g., CQI). The UE sends NACK to the higher layer if the UE cannot successfully decode the received data block/packet (e.g. transport block received in the DL data channel e.g. PDSCH). On the other hand, the UE can send ACK (acknowledgement) to the higher layer if the UE can successfully decode the received data block. The data block is successfully decoded by the UE if the UE passes the cyclic redundancy check (CRC) of the CRC appended to the received data packet. Otherwise, the data block is not successfully decoded by the UE. On the other hand, if number NACKs for PDSCH reception falls below certain threshold (or number of ACKs for PDSCH reception exceeds certain threshold) then the UE can select less robust/generic AI/ML model for performing the CSI measurement (e.g., CQI). The AI/ML model trained for more versatile or larger range of radio environments is more robust compared to the AI/ML model trained for limited number of or specific radio environments. For example, the AI/ML model trained for an environment with delay spread of D1 is more robust than the AI/ML model trained for an environment with delay spread of D2; where in one example, |D1|>|D2| and in another example, |D1|>(|D2|+G1), where G1 is a threshold. The delay spread is a duration during which the UE receives one or more paths of the signal whose received power is above certain threshold and/or the received power of all the subsequent paths is at least Z1 dB (e.g. −3 dB) above the first received path in time. In another example, the AI/ML model trained for an environment with Doppler frequency of Fd1 is more robust than the AI/ML model trained for an environment with Doppler frequency of Fd2 for the same carrier frequency and speed; where in one example, | Fd1|>|Fd2| and in another example, |Fd1|>(|Fd2|+G2), where G2 is a threshold.

One node-based embodiment method 400 under the present disclosure is shown in FIG. 5. Method 400 is a method performed by a network node for configuring a UE for using an AI/ML model, for one or more measurement procedures. Step 410 is obtaining a first set of one or more criteria, which can be used by the UE for selecting between at least two AI/ML models for one or more measurement procedures. Step 420 is transmitting information about the obtained first set of one or more criteria to the UE. Method 400 can comprise a variety of additional or alternative steps. For example, method 400 can further comprise obtaining a second set of one or more criteria, which can be used by the UE for selecting between at least one AI/ML model and a measurement model (e.g., another AI/ML model, a non-AI/ML model) for performing other or the same measurement procedure. The method could also comprise transmitting information about the obtained second set of one or more criteria to the UE. Another optional step could be receiving the results of the measurements performed by the UE based on the one or more AI/ML models or the measurement model. Another optional step could be using the received results for performing one or more operational tasks (e.g. scheduling data, positioning, cell change, etc.).

One aspect of certain embodiments described herein is that depending upon the results or outcome of the measurement procedure, the UE switches between different AI/ML models based on one or more criteria which are associated with the type of the measurement procedure. For example, under unfavorable measurement results (e.g., lowest CQI, beam failure detection, out of sync detection, radio link failure, cell change failure, etc), the UE can switch to a more robust AI/ML (e.g., trained in wide range of radio environment). On the other hand, under favorable measurement results (e.g., CQI within expected range, in-sync detection etc.), the UE switches back to more specific AI/ML (e.g., trained for the specific radio environment). The term switching between the models is interchangeably called as selecting between the models or changing between the models or swapping between the models. The ‘models’ may refer to either ‘at least two AI/ML models’ or ‘at least one AI/ML model and at least one measurement model’.

One example use case or scenario assumes that a UE is configured with at least two AI/ML models: a first AI/ML (AM1) model and a second AI/ML (AM2) model. Certain embodiments are described assuming that the UE is configured with two AI/ML models for the sake of simplicity of explanation; but they are applicable for any number of AI/ML models e.g. n number of AI/ML models comprising a set of models, W={AM1, AM2, AM3, . . . , AMn}.

The UE can be configured with the AI/ML models in the set, W (e.g., W comprising at least AM1 and AM2 models) by one or more of the following principles:
By receiving a message from a network node e.g., via RRC, MAC-CE (Medium Access Control-Control Element) or DCI message or command. For example, the AI/ML models are trained in another node (e.g., a base station) and the information about the trained models is transmitted to the UE via a signaling message.
The AI/ML models autonomously trained by the UE e.g., by online or offline training based on the samples collected by the UE. Once the model is trained then the UE can use it for performing one or more measurements.
   The configured AI/ML models can further be updated by the UE itself and/or by receiving information from a network node as part of the life cycle management (LCM) of the models.

The carrier frequencies on which the UE is configured to receive signals (e.g., PDSCH, SSB, CSI-RS etc.) may belong to a certain frequency range (FR). Examples of FR are within frequency range 1 (FR1), within frequency range 2 (FR2), within frequency range 3 (FR3) etc. In one example frequencies within FR2 are frequencies above a certain threshold e.g., 24 GHz or higher. In another example the frequencies in FR2 may vary between 24 GHz to 52.6 GHz. In another example, frequencies in FR2 may vary between 24 GHz to 71 GHz. Frequencies in FR1 are below the frequencies in FR2. In one example frequencies in FR1 range between 410 MHz and 7125 MHz. In higher frequencies (e.g. mmwave, FR2, FR3 etc) due to higher signal dispersion, the transmitted signals are beamformed by a base station e.g. transmitted in terms of SSB beams. The beam-based transmission and/or reception may also be used in lower frequencies e.g. in FR1. The UE creates a receive (RX) beam at its receiver to receive the signal (e.g., PRS, SSB, CSI-RS etc.). A DL RS (e.g., PRS, SSB, CSI-RS etc.) may therefore interchangeably be called a DL beam, spatial filter, spatial domain transmission filter, main lobe of the radiation pattern of antenna array etc. The term beam used herein may refer to RS such as PRS, SSB, CSI-RS etc. The RS or beams may be addressed or configured by an identifier, which can indicate the location of the beam in time in beam pattern e.g., beam index such as SSB index indicate SSB beam location in the pre-defined SSB format/pattern, beam index such as CSI-RS index indicate CSI-RS beam location in the pre-defined or pre-configured CSI-RS format/pattern etc. The measurement on such RS may also be called a beam measurement or beam based measurement. The UE may also combine two or more beam measurements to obtain a combined or overall measurement result. Beamforming or spatial filtering is a signal processing technique used in radio communications for directional signal transmission (transmit beamforming) or reception (receive beamforming).

The UE can be configured to perform one or more measurements on a RS transmitted by one or more cells operated or managed by a network node. To assist the UE in performing the measurements, the UE can be configured by the network node with information related to RS configuration e.g., via RRC (Radio Resource Control) signaling. The RS configuration information may be part of a measurement object (MO). In general, the RS configuration may comprise of one or more parameters e.g., RS index or identifier (e.g., RS1), RS duration or occasion or window, RS periodicity and time offset etc. Examples of RS are SSB, CSI-RS, PRS, SRS etc. Examples of RS configuration are RLM-RS configuration, SMTC (SSB Measurement Timing Configuration) configuration, CSI-RS configuration, PRS (Positioning Reference Signal) configuration, SRS (Sounding Reference Signal) configuration etc. Each SMTC configuration transmitted to the UE in a MO is associated with corresponding SMTC parameters e.g., SMTC index or identifier (e.g., SMTC1), SMTC duration, SMTC periodicity and time offset etc. Wherein, SMTC1 indicates index or identifier of SMTCs configured by network, it can also be referred to as RRC IE parameter.

### AI/ML Model Selection Criteria

The UE can use any of the at least two or more AI/ML models or it can use a measurement model for performing one or more measurement procedures. However, different AI/ML models are suitable for performing the measurements under different conditions or scenarios. For example, a first AI/ML model (AM1) can be suitable for performing the measurements under a first condition/scenario whereas a second AI/ML model (AM2) can be suitable for performing the measurements under another condition/scenario e.g. second condition/scenario. According to certain embodiments of the current disclosure, an optimum measurement performance is realized by using the AI/ML model which is relevant to or is suitable for the associated condition/scenario.

As set forth above regarding FIG. 4, according to one embodiment, the UE can obtain a first set of criteria for selecting between at least two AI/ML models, AM1 and AM2, and selects between AM1 or AM2 based on the obtained first set of criteria. The UE can further use the selected AI/ML model for performing one or more measurements. The term AI/ML model selection may also be called AI/ML model selection switching, transitioning, adaptation etc.

In another aspect of this embodiment, the UE further obtains a second set of criteria for selecting between at least one AI/ML model and a measurement model and selects between the at least one AI/ML model and the measurement model based on the obtained second set of criteria. The UE further uses the selected AI/ML model for performing one or more measurements. When using the measurement model, the UE obtains the measurement results by obtaining one or more measurement samples/snapshots on the signals (e.g. RS such as SSB, CSI-RS, DL PRS, SL PRS etc.) transmitted between a network node (e.g. base station) and the UE or between the UE and another UE i.e. based on the actual measurement. The UE may combine (e.g. average, sum, product, ceiling, floor, xth percentile etc.) the obtained one or more measurement samples/snapshots to obtain the final measurement results. One general example of the second set of the criterion is that if the UE cannot obtain reliable measurement results based on any of the AI/ML models (e.g. if the measured value is out of the reportable range, if estimated CQI is out of range (e.g. with index #0), if number of NACKs exceed certain threshold, number of cell change failures exceed certain threshold etc.) then the UE stops using the AI/ML model and start using the measurement model for performing the measurements. Another example of the second set of the criterion is that if the UE cannot obtain reliable measurement results based on the reference or baseline AI/ML model (e.g. using model AM2 if the measured value is out of the reportable range etc.) then the UE stops using the reference AI/ML model and start using the measurement model for performing the measurements. The UE may revert to using the AI/ML model once the measurement results based on the measurement model becomes reliable and remain reliable for certain time period. The measurement results are considered reliable if they meet one or more reliability criteria; otherwise they are considered unreliable. Examples of such reliability criteria could be: measurement results are within a reportable range; measurement results are within an expected range; the value of the measurement value is below a first threshold (TH1) and/or above a second threshold (TH2) etc. The reportable range, the expected range, TH1, TH2 etc., can be pre-defined or configured by the network node. The time period, which can be termed as hysteresis time or coherence time window, can be pre-defined or configured by the network node or it can be determined by the UE.

In one example, the UE can obtain the criteria according to one or more of the following rules:
Pre-defined information e.g., the criteria or associated parameters are pre-defined.
By receiving information associated with or from a network node (e.g., via RRC, MAC-CE or DCI).
Pre-configuration in the UE e.g., by retrieving it from the SIM/USIM card or eSIM, application program.

The one or more criteria for the AI/ML model selection may further depend on a type of measurement procedure, which is performed based on the selected AI/ML model. Some examples of the measurement procedures performed by the UE are described above.

### Examples of AI/ML Model Differences

Among a set of models, e.g., AM1 and AM2 in set W, one model can be regarded as a reference or baseline AI/ML model, e.g., AM2. For example, even when a larger set of the models (e.g., n models) in set, “W” are configured at least one of the models (e.g., the model AM2) can be designated as a reference or baseline AI/ML model. Examples of the differences between AM1 and AM2 could be various, including the following possibilities.

In general, a reference/baseline model, e.g., AM2, can be applied by the UE for performing the measurements under critical scenario or condition e.g., when the radio link quality becomes worse (falls below) than a certain threshold as elaborated with several examples below. On the other hand, AM2 can be applied by the UE for performing the measurements under normal condition (i.e. under non-critical scenario or condition) e.g. when the radio link quality is in acceptable range such as when it is above certain threshold.

In another example, the baseline model (AM2) is trained for larger number of scenarios (e.g., radio environments) compared to model AM1. This is elaborated with several examples. For instance, in one example, model AM2 is trained from the data collected in radio environment comprising both line of sight (LOS) and non-LOS (NLOS) paths, whereas AM1 is trained from the data collected in radio environment comprising one of either LOS or NLOS paths. In another example, model AM2 can be trained to predict an output by using X2 as input data and model AM1 can be trained to predict an output by using X1 as an input data. Input data X1 and X2 denote features that are used to train AI/ML models AM1 and AM2 respectively. The outcome of inferencing from AM1 and AM2 may or may not be the same. X1 and X2 may indicate different features derived from different types of signals or X1 and X2 may indicate different features derived from same signal type. In another example, model AM2 can be trained from the data collected in radio environment comprising of urban/typical urban (TU), sub-urban (SU) and rural area (RA) regions. On the other hand, AM1 can be trained from the data collected in radio environment comprising of any one of the TU, SU and RA regions. The radio channel characteristics in TU, SU and RA are different for the same frequency. Examples of the radio channel characteristics are Doppler frequency (Fd), Doppler spread (DFd), coherence time, multipath delay spread (δT) etc. For example, typically the magnitude of the δT (|δT|) of the radio channel in TU is smaller than in SU; and the (|δT| in SU is smaller than in RA. In another example, typically the Fd of the radio channel in TU is smaller than in SU; and the Fd in SU is smaller than in RA. Therefore, the UE can use AM2 in wide range of radio environments while it can use AM1 in specific or limited radio environment. However, AM1 leads to optimal or best possible performance under the given condition (e.g., maximum possible/achievable radio link quality such as SNR, SINR, etc.) if it is used in the same or similar radio environment in which and for which it has been trained. On the other AM2 gives acceptable performance in a wide range of radio environments i.e., conservation results. Therefore, in general the AM2 is more versatile, robust and resilient but also more conservative than AM1. The AM2 is therefore suitable when the measurement obtained based on AM1 is unreliable or tends to become less accurate.

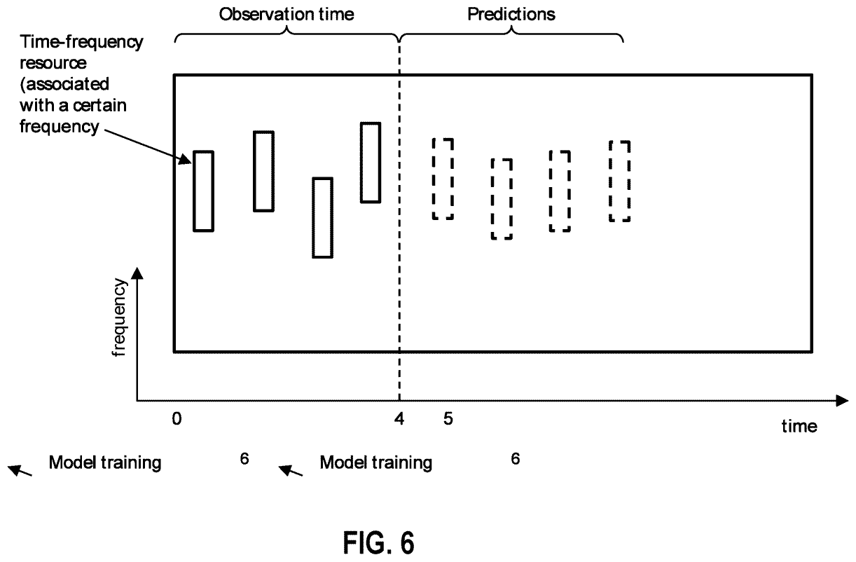

In another example of differences between models, the baseline model (AM2) can be “online” trained based on the data collected in the ongoing radio session for the UE. The baseline model can be trained using models of low complexity such as an autoregressive (AR) model. This hence comprises solution that can be done “online” in comparison to the offline trained model in the previous example. The “online” model described can be assumed to be simpler than a model trained offline, where offline models could utilize learnings from a large dataset. Online models such as AR-models only utilizes the dataset collected by the individual UE. For example, the UE can collect data and perform predictions within one session e.g., during an RRC connection instance. Hence the UE might collect data during a first time-period and performs predictions during a second time-period. One simple method could comprise an autoregressive model (AR) giving at each time sample t the output variable X(t) that depends linearly on its own previous output variables X(t−1), . . . , X (t−p) at time samples (t−1) through (t−p), respectively, where p is the AR model order, given by

$$X ( t ) = {b}_{0} + {\sum }_{i = 1}^{p} {b}_{i} X ( t - i ) ,$$

where the UE first learns the parameters b₀, b₁, b₂, . . . bp during the observation time and uses the data based on the prediction. The steps of such procedure are shown below by the example in FIG. 6, which shows an example of the AI/ML model collecting data and making prediction during different times in tandem manner. FIG. 6 shows an example when p=2, the first time-period referred to as the observation time dedicated to learn b₀, b₁ and b₂ while training the model over four different channel bandwidth transmissions. The output variable predictions will be carried out during the second time-period.

### Model Selection and Switching

Examples of the criteria for selecting between different AI/ML models include, but are not limited to: criteria related to CSI; criteria related to RLP; criteria related to PMP; criteria related to CCP; and criteria related to internal model metrics. Further examples of criteria are given below.

### CSI-Related Criteria

In one example, the UE selects between the models, AM1 and AM2, based on a comparison between the estimated value of CSI (e.g. CQI) and a threshold. Possible embodiments can be illustrated with a few examples.

In one example, if the estimated CQI based on model AM1 is below threshold (H11) then the UE selects the model AM2 for further estimation of the CQI. This may be the case when the estimated CQI based on model AM1 is underestimated compared to the expected value of the CQI, or considering that AM2 has been trained for larger number of propagation environments. For example, the UE may underestimate the CQI because AM1 was being used by the UE in an environment or scenario for which it has not been trained and calibrated. In another example, if the estimated CQI based on model AM1 is above certain threshold (H12) then the UE selects the model AM2 for further estimation of the CQI. This may be the case when the estimated CQI based on model AM1 is overestimated compared to the expected value of the CQI, or considering that AM2 has been trained for larger number of propagation environments. For example, the UE may overestimate the CQI also because AM1 was being used by the UE in an environment or scenario for which it has not been trained and calibrated. In another example, if the estimated CQI based on model AM1 is a reference CQI then the UE selects the model AM2 for further estimation of the CQI. In one example, the reference CQI is either the smallest CQI, invalid CQI (e.g. CQI with certain index e.g. index=0) or the highest (e.g. CQI index=15) etc. The reference CQI can be pre-defined or configured by the network node.

In another example, the UE selects between the models, AM1 and AM2, based on a HARQ feedback (e.g. ACK, NACK, BLER etc) associated with DL data reception (e.g. PDSCH reception). The UE delivers ACK to the higher layer if the UE can successfully decode a data block received on the DL data channel; otherwise the UE delivers NACK to the higher layer. For example, the UE selects the model based on one or more of: a comparison between HARQ BLER and a threshold, a comparison number of ACKs and a threshold, a comparison number of NACKs and a threshold etc. The HARQ BLER is the ratio of total number of NACKs delivered to the higher layers to the total number of ACKs and NACKs delivered to the higher layers during certain time period. The HARQ BLER can be expressed in percentage, in log scale, ratio (unitless quantity) etc. The following examples show possible embodiments. In one example, if the BLER estimated by the UE using model AM1 during certain time period (T11) exceeds certain threshold (H13) then the UE selects the model AM2 for further estimation of the CQI. The DL data scheduling by the serving BS is based on the UE's reported CQI that is matched to a specific modulation and coding scheme (MCS). Therefore, this may be the case when the estimated CQI based on model AM1 exceeds the expected CQI (is overestimated compared to the expected value of the CQI). In another example, if the number of NACKs estimated by the UE using model AM1 during certain time period (T12) exceeds certain threshold (H14), then the UE selects the model AM2 for further estimation of the CQI. In another example, if the consecutive number of retransmissions for the same DL data block received by the UE exceeds certain threshold (H14) then the UE selects the model AM2 for further estimation of the CQI. The UE may be using model AM1 before it selects model AM2.

In another example, the UE may select the model based on the geographical area or zone of the cell e.g. serving cell. In some examples AM1 is used when the UE is in geographical area 1 and AM2 when the UE is in geographical area 2 and so on etc. The UE may be configured with a mapping table or relation between a set of geographical areas and a corresponding set of the AL/ML models. The geographical area can be defined in terms of a set of 2 or 3 dimensional geographical coordinates. The UE can determine the geographical area in which it is located based on one or more positioning techniques e.g. by global navigational satellite system (GNSS) such as GPS, Galileo, by terrestrial positioning technique (e.g. enhanced cell ID, fingerprinting, time difference of arrival (TDOA), angle of arrival (AoA) of signals etc) etc.

In another example, the NW node may indicate the UE to switch the model based on the number of NACKs received from the UE over a certain period. In some examples, if the number of NACKs received from the UE at the NW node is more than a certain threshold, then the NW node may indicate the UE to switch the model e.g. to AM2.

In another example, the NW may indicate the UE to switch from AM1 or AM2 or other model to not using any AI/ML model and perform the measurements using legacy or non-prediction-based method (e.g. measurement model).

In another example, the UE compares an average CQI with another measurement related data (e.g. RSRP) in order to predict the accuracy of the CQI measurements being provided based on AM1. If the accuracy of the CQI based on the comparison falls below a certain threshold then the UE switches to AM2, or to a non-AI CQI computation (e.g. based on the measurement model).

In another example, the UE obtains information of the quality of the decoding based on internal metrics such as e.g. log-likelihood ratios, channel estimation quality or Bit Error Rate (BER) and compares these metrics to the expected decoding quality based on the CQI predicted by AM1 or AM2. If the quality is better or worse than a certain threshold then the UE switches to the relevant model. For example, if the quality of the decoding (e.g. BER) is better than expected when using AM2, then the UE may switch to AM1. If the quality is worse than expected using AM1, then the UE may switch to AM2.

### RLP-Related Criteria

The UE selects between the models, AM1 and AM2, based on the result or outcome of the radio link procedure. Possible embodiments can be illustrated with a few examples.

In one example, if the UE has detected a beam failure (e.g. triggered BFD) in a serving cell then the UE selects the model AM2 for estimation of the radio link quality for the purpose of performing one or more procedures related to the LRP/BM e.g. for beam failure detection, candidate beam detection, beam failure recovery etc. It is assumed that the UE has been using model AM1 when the beam failure was detected. This may be the case when the estimated radio link quality based on model AM1 is unreliable e.g. underestimated or overestimated wrt the expected value. In one example, the BFD is detected if the hypothetical BLER of a DL control channel (e.g. PDCCH) is above a certain threshold (e.g. 10%). The hypothetical BLER is determined by the UE based on the mapping or relation between DL radio link quality estimated by the UE on a DL RS (e.g. SSB, CSI-RS etc) and hypothetical BLER.

In another example, if the UE is unable to perform candidate beam detection (CBD) within certain time period (T21) after the UE has triggered the beam failure (e.g. triggered BFD) in a serving cell then the UE selects the model AM2 for the CBD. The UE uses the model AM2 for further performing the CBD.

In another example, if the UE has detected at least K1 number of candidate beams within certain time period (T22) then the UE selects the model AM2 for the CBD. The UE uses the AM2 for further performing the CBD. This scenario may occur due to overestimation of detecting the beams based on the model AA1.

In another example, if the UE has detected more than N1 number of out-of-sync (OOS) during certain time period (T23) then the UE selects the model AM2 for further estimation of the radio link quality for the purpose of performing one or more procedures related to the RLM e.g. for OOS detection, IS detection, RLF, RRC connection re-establishment etc. It is assumed that the UE has been using model AM1 when the N1 number of the OOS was detected. This may be the case when the estimated radio link quality based on model AM1 is unreliable e.g. underestimated with respect to the expected value.

In another example, if the UE has triggered a radio link failure (RLF) then the UE selects the model AM2 for further estimation of the radio link quality for the purpose of performing one or more procedures related to the RLM e.g. for OOS detection, IS detection, RLF, RRC connection re-establishment etc. It is assumed that the UE has been using model AM1 when the RLF was triggered. In one example, the UE triggers the RLF upon expiry of a RLF timer (e.g. T310 timer). The UE starts the RLF timer upon detection of N2 number of connective OOS, detection of N3 number of OOS within certain time period (T24) etc.

In another example, if the UE has triggered N4 number of times the RLF within certain time period (T25) then the UE selects the model AM2 for further estimation of the radio link quality for the purpose of performing one or more procedures related to the RLM e.g. for OOS detection, IS detection, RLF, RRC connection re-establishment etc. It is assumed that the UE has been using model AM1 when N4 number of the RLF was triggered by the UE.

In some examples, when the UE performs TRP specific BFD or CBD, the UE may select AM1 for one TRP (e.g., TRP1) and AM2 for other TRP (e.g., TRP2) and if anyone of the issues discussed in above examples occur, then the UE may switch the models used for respective TRPs for performing BFD or CBD or other LR procedures (e.g., UE switches AM2 to TRP1 and AM1 to TRP2).

### PMP-Related Criteria

The UE selects between the models, AM1 and AM2, based on the result or outcome of the positioning measurements related to the positioning measurement procedure (PMP). Possible embodiments can be illustrated with a few examples.

In one example, if the measured positioning measurement value is outside an expected value range(s) then the UE selects the model AM2 for performing further positioning measurement. The UE may also discard the positioning measurement value obtained based on the AM1 as it may be considered unreliable or unrealistic under given radio environment and deployment scenario. The expected value range can be pre-defined or configured by the network node. An example of the expected value range is the expected RSTD and the positioning measurement is RSTD. Another example of the expected value range is the expected channel impulse response (CIR) and the positioning measurement is CIR. Another example of the expected value range is the expected power delay profile, and the positioning measurement is PDP. Another example of the expected value range is the expected delay profile, and the positioning measurement is DP. Another example of the expected value range is the expected reference signal received path power and the positioning measurement is RSRPP.

In another example, if the measured values of at least P1 number of the positioning measurements are outside an expected value range(s) then the UE selects the model AM2 for performing further positioning measurement. The UE may also discard the positioning measurement values obtained based on the AM1 as they may be considered unreliable or unrealistic under given radio environment and deployment scenario. The parameter, P1, may be pre-defined or configured by the network node.

In another example, if the uncertainty in the quality of the timing positioning measurement results exceeds certain threshold, then the UE selects the model AM2 for performing further positioning measurement. The UE may also discard the positioning measurement value obtained based on the AM1 as it may be considered unreliable or unrealistic under given radio environment and deployment scenario. Examples of the timing positioning measurements are RSTD, time of arrival (TOA), UE Rx-Tx time difference etc. Examples of the parameter/metric defining an uncertainty of the quality of the timing positioning measurement are timing error margin (TEM), received signal's TEM (Rx-TEM), received and transmitted signals' TEM (RxTx-TEM), integrity of measurement etc. The timing error margin (TEM) is associated with a timing error group (TEG), which can be pre-defined or configured by the network node or determined by the UE autonomously. TEM may also be called as simply margin or timing margin or timing error or panel error etc. The TEM typically depends on radio chain used for the timing positioning measurement that depends on the UE implementation. The UE estimates the TEM during the timing positioning measurement and may also report the TEM value to the network node (e.g. positioning node) along with the timing positioning measurement results.

In another example, if the uncertainty in the quality of the timing positioning measurement results exceeds certain threshold for more than P2 number of times during certain time period (T31), then the UE selects the model AM2 for performing further positioning measurement. The UE may also discard the positioning measurement value obtained based on the AM1 as it may be considered unreliable or unrealistic under given radio environment and deployment scenario.

In another example, if UE is not able to perform input measurement required by AM1, then the UE selects the model AM2 for performing further positioning measurements. The UE may also discard the positioning measurement value obtained based on the AM1 as it may be able to perform complete set of measurements required by AM1 for inferencing an output.

### CCP-Related Criteria

The UE selects between the models, AM1 and AM2, based on the result or outcome of the cell change procedure (CCP). Possible embodiments can be illustrated with a few examples.

In one example, if the UE does not meet the cell selection criteria S based on the measurements (e.g. RSRP, RSRQ etc) performed based on AM1, then the UE selects the model AM2 for performing the measurements to further evaluate the cell selection criteria S. In one example, the UE reverts to using the model AM1 if the UE meets the cell selection criteria S based on AM2. In another example, the UE reverts to using the model AM1 if the UE meets the cell selection criteria S based on AM2 for at least certain time period (T41). The UE measures the signal strength (e.g. RSRP) and signal quality (e.g. RSRQ) of the serving cell and evaluates the cell selection criterion S for the serving cell at least once every G1*DRX cycle in low activity RRC state (e.g. in RRC idle state, RRC inactive state etc); where G1≥1. In one example the cell selection criterion S for a cell (e.g. serving cell) is fulfilled when the UE determines that the following condition is met by the UE:
Srxlev>0 AND Squal>0; where Srxlev is function of signal strength (e.g. RSRP) and Squal is function of signal quality (e.g. RSRQ);
Otherwise, the cell selection criterion S for the cell is not fulfilled.

In another example, if the UE does not meet the cell selection criteria S based on the measurements (e.g. RSRP, RSRQ etc) performed based on AM1 for more than Q1 number of times during certain time period (T42), then the UE selects the model AM2 for performing the measurements to further evaluate the cell selection criteria S. In one example, the UE reverts to using the model AM1 if the UE meets the cell selection criteria S based on AM2. In another example, the UE reverts to using the model AM1 if the UE meets the cell selection criteria S based on AM2 for at least certain time period (T42). In another example, the UE reverts to using the model AM1 if the UE does not fail the cell selection criteria S based on AM2 during at least certain time period (T43).

In another example, the UE selects and uses the model AM2 for performing measurements for the cell selection to the selected PLMN (Public Land Mobile Network). The UE may perform the cell selection to the selected PLMN during the initial cell search (e.g. when powered on) or after the UE has failed the selection criteria S for the serving cell. In an example, the UE reverts to using the model AM1 for performing the measurements if the UE has successfully performed the cell selection procedure.

In another example, the UE selects and uses the model AM2 for performing measurements for the cell selection to the selected PLMN provided that the UE is unable to perform the cell selection to the selected PLMN during certain time period. In an example, the UE reverts to using the model AM1 if the UE has successfully performed the cell selection procedure. In another example, the UE reverts to using the model AM1 for performing the measurements if the UE has not failed the cell selection procedure for more than certain number of times during certain time period.

In another example, the UE selects and uses the model AM2 for performing measurements after the cell change (e.g. cell reselection, RRC connection re-establishment etc.) to the target cell (e.g. from old serving cell (cell1) to new serving cell (cell2)) during certain time period (e.g. up to X1 number of DRX cycles, up to X2 seconds etc). After that the UE reverts to using the model AM1 for performing the measurements.

In another example, the UE selects and uses the model AM2 for performing measurements if the UE fails (unable) to perform the cell change (e.g. cell reselection, RRC connection re-establishment etc) to the target cell (e.g. from cell1 to cell2). In one example, upon successful completion of the cell change the UE reverts to using the model AM1 for performing the measurements.

In another example, the UE selects and uses the model AM2 for performing measurements if the UE fails (unable) to perform the cell change (e.g. cell reselection, RRC connection re-establishment etc) to the target cell (e.g. from cell1 to cell2) using model AM1 for more than certain number of times (K11) during certain time period. In one example, upon successful completion of the cell change the UE reverts to using the model AM1 for performing the measurements. In another example, the UE reverts to using the model AM1 for performing the measurements provide that the UE does not fail the cell change for more than certain times (K12) using model AM2 during certain time period.

In another example, the UE selects and uses the measurement model for performing measurements if the UE fails (unable) to perform the cell change (e.g. cell reselection, RRC connection re-establishment etc.) to the target cell (e.g. from cell1 to cell2) based on model AM2 for more than certain number of times (K21) during certain time period. In one example, upon successful completion of the cell change the UE reverts to using the model AM1 or AM2 for performing the measurements. In another example, the UE reverts to using the model AM1 or AM2 for performing the measurements provide that the UE does not fail the cell change for more than certain times (K22) using the measurement model during certain time period.

In another example, the UE selects and uses the model AM2 for performing measurements if the measurement being performed using AM1 is out of the range. The measurement (e.g. RSRP) is considered out of the range if the measurement value is outside the reportable range, which can be pre-defined or configured by the network node. For example, if the RSRP reportable range is between −40 dBm to −130 dBm, then the measured RSRP of −135 dB is out of range.

### Internal Model Metrics Criteria

In some embodiments, the UE may have access to metrics from within an AI/ML model that predict the reliability of the model prediction and may base the decision to switch models on these metrics. An example may be a confidence level for a beam prediction or a CQI prediction or positioning prediction. If the UE is, for example applying AM1 and the confidence level falls below a certain threshold then it may switch to AM2. If the confidence level using AM2 falls below a certain threshold then the UE may switch to using a non-AI algorithm (e.g. based on measurement model).

In some examples, the UE indicates the change from AI based model to non-AI based model to the NW node. The indication to the NW node can be in any of the UL messages or UL channels (e.g., using UCI or MAC CE or etc.). In some other examples, the change from AI to non-AI model may be marked as an event and the same event may be reported to the NW node by using any of the UL channels (e.g. PUCCH (Physical Uplink Control Channel), PUSCH etc.) or UL messages (e.g. RRC, MAC-CE etc.).

According to another embodiment, the UE informs the network node that the UE has switched or is going to switch or is expected to switch the AI/ML model for performing one or more type of measurement procedures. The UE may transmit to the network node, information related to the AI/ML model used or being used by the UE before the model switching and/or the information related to the AI/ML model used or is going to be used by the UE after the model switching. The information may comprise e.g. pre-defined or configured identifier of the AL/ML model. The UE may further inform the network node information related to the reason or criterion, which has triggered the UE to switch between the at least two AI/ML models or which has triggered the UE to switch between the AI/ML model and the measurement model. The network node receiving this information may use it for performing one or more operational tasks e.g. modifying one or more of data scheduling, transmission scheme (e.g. reducing or increasing number of configured MIMO layers etc).

### Measurement Behaviour Upon Model Selection/Switching/Modification

The UE behaviour of the measurement being performed by the UE upon switching between different AI/ML models (e.g. between AM1 and AM2) or between any AI/ML model and the measurement model or when the AI/ML model is modified should be defined. This is to ensure consistent UE measurement behaviour and performance. The UE measurement behaviour can be specified in terms of a rule, which can be pre-defined or configured by the network node. Some examples of the rules defining the UE behaviour upon switching between different AI/ML models or between an AI/ML model and the measurement model are given below.

In one example of the rule, the UE restarts a measurement after switching between the AI/ML models or between the AI/ML model and the measurement model or when the AI/ML model is modified or when the AI/ML model is activated or deactivated. This rule may further depend on the type of the measurement. For example, the UE restarts certain type of timing measurement (e.g. timing positioning measurements like UE Rx-Tx (reception-transmission)) after the AI/ML model is modified, activated, deactivated or switched with another AI/ML model or with the measurement model. In another example, a certain type of CSI measurement (e.g. CQI) restarts AI/ML model is modified, activated, deactivated or switched.

In another example of the rule, the UE continues performing a measurement after switching between the AI/ML models or between the AI/ML model and the measurement model or when the AI/ML model is modified or when the AI/ML model is activated or deactivated. This rule may also depend on the type of the measurement. For example, the UE continues certain type of signal measurement (e.g. signal strength such as RSRP, signal quality such as RSRQ etc) after the AI/ML model is modified, activated, deactivated or switched with another AI/ML model or with the measurement model. In another example, certain type of CSI measurement (e.g. CQI) restarts AI/ML model is modified, activated, deactivated or switched.

In another example of the rule, the UE stops performing a measurement after switching between the AI/ML models or between the AI/ML model and the measurement model or when the AI/ML model is modified or when the AI/ML model is activated or deactivated. The UE may resume performing the measurement after a certain time period. This rule may also depend on the type of measurement.

In another example, the UE requests the network node to send updated assistance data/measurement configuration after the UE has switched or is expected to switch between the AI/ML models or between the AI/ML model and the measurement model or when the AI/ML model is modified or when the AI/ML model is activated or deactivated. The UE may resume performing the measurement after receiving the updated assistance data from the network. This rule may also depend on the type of measurement.

In another example, the UE requests the network node or informs the network node that that it is going to start performing measurements based on non-AI approach instead of performing predictions using an AI/ML model. This would require the NW node to transmit the reference signals (RS) or has to increase their transmission periodicity of the RS used by the UE for performing the measurements. For example, the NW node may prefer to transmit the RS or increase the RS (e.g. CSI-RS) periodicity instead of relying on UE predictions to estimate the “in-between” unmeasured CSI-RS resources. If the UE has switched back to an AI/ML model, then the UE might need to be reconfigured with a lower RS (e.g., CSI-RS) periodicity.

### Additional Embodiments

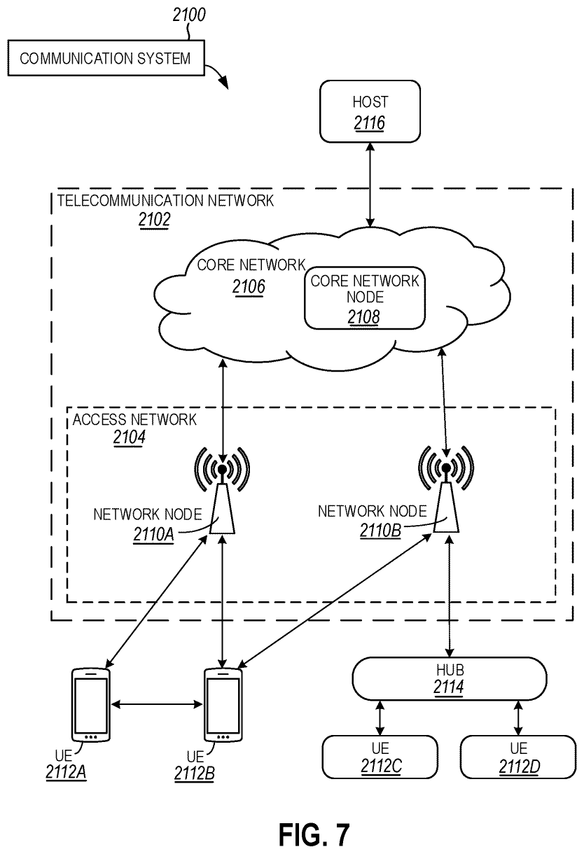

FIG. 7 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

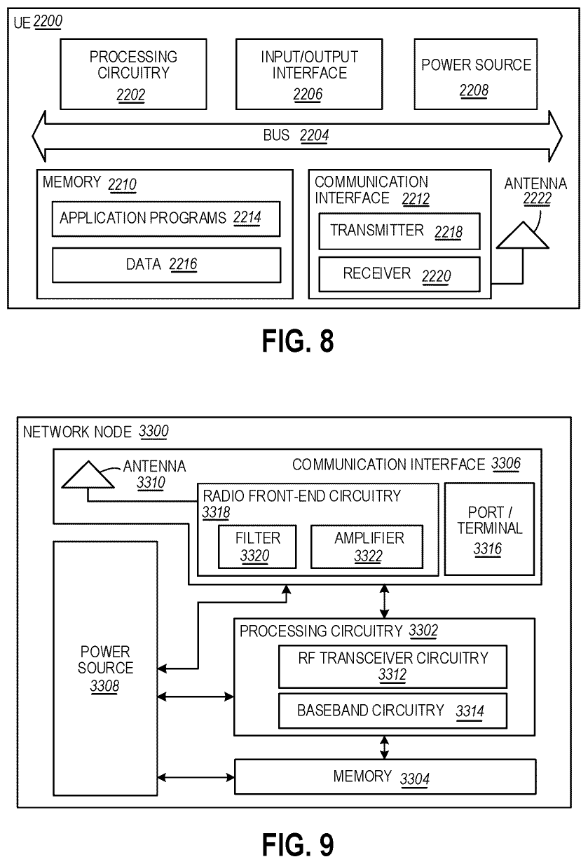

FIG. 8 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

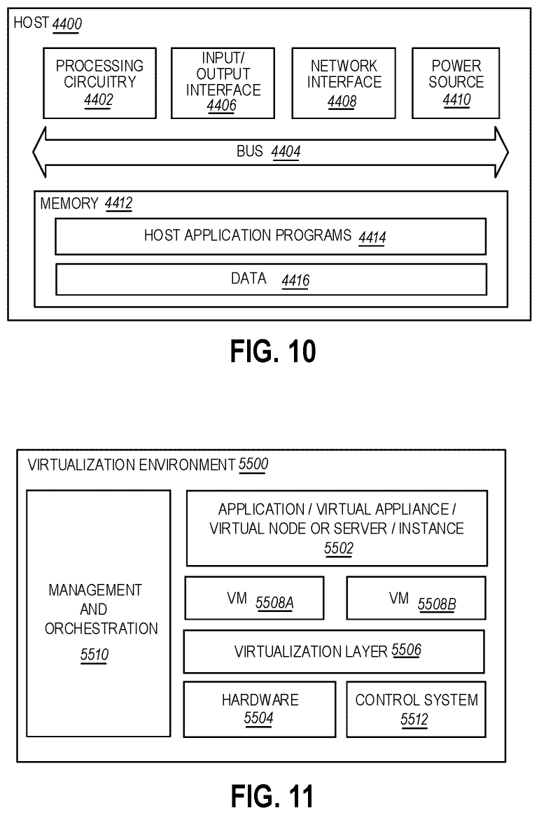

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 9 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

FIG. 10 is a block diagram of a host 4400, which may be an embodiment of the host 2116 of FIG. 7, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 8 and 9, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

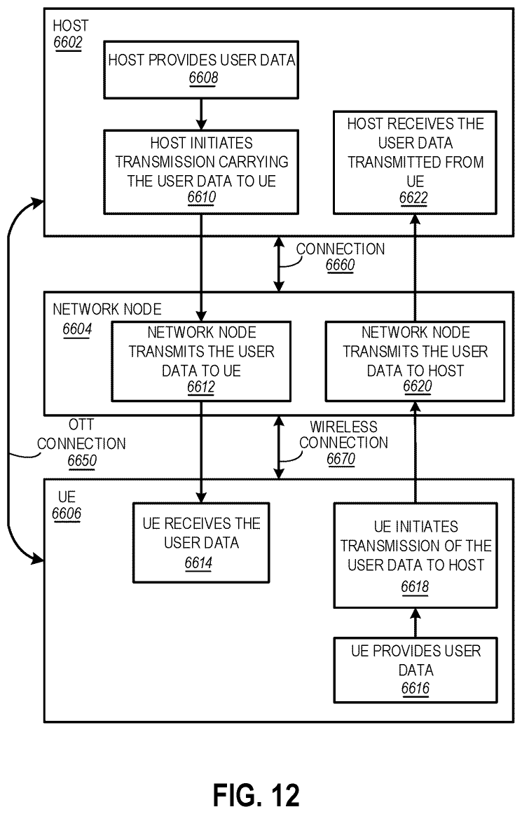

FIG. 12 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 7 and/or UE 2200 of FIG. 8), network node (such as network node 2110a of FIG. 7 and/or network node 3300 of FIG. 9), and host (such as host 2116 of FIG. 7 and/or host 4400 of FIG. 10) discussed in the preceding paragraphs will now be described with reference to FIG. 12.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 7) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages—so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A method performed by a user equipment, UE, for using an Artificial Intelligence/Machine Learning, AI/ML, model, for one or more radio network operations, the method comprising:
obtaining a first set of one or more criteria for selecting between at least two AI/ML models;
performing at least one measurement procedure to obtain one or more measurements; and
using the obtained one or more measurements and the first set of one or more criteria to select between the at least two AI/ML models.

2. The method of claim 1, further comprising performing the one or more radio network operations with the selected AI/ML model.

3. The method of claim 1, wherein the one or more radio network operations comprises at least one of: beam management; Channel State Information, CSI, measurement; predicting a quality of one or more reference signals; positioning measurement; predicting timing information of one or more positioning reference signals.

4. The method of claim 1, wherein the one or more measurement procedures comprises at least one of: channel state information, CSI, measurement; radio link procedure, RLP; positioning measurement; cell change procedure.

5. The method of claim 1, wherein at least one of the first set of one or more criteria are received from a network node.

6. The method of claim 1, wherein at least one of the first set of one or more criteria are pre-defined or pre-configured at the UE.

7. The method of claim 1, wherein the performing comprises inferring or predicting the one or more measurements based on the output of one of the at least two AI/ML models.

8. The method of claim 1, further comprising;
obtaining a second set of one or more criteria for switching between one of the at least two AI/ML models and a measurement model for performing the at least one measurement procedure;
selecting between the one of the at least two AI/ML models and the measurement model based at least in part on the second set of one or more criteria; and
using the selected one of the at least two AI/ML models or the measurement model for performing the at least one measurement procedure.

9. The method of claim 8, wherein using the selected one of the at least two AI/ML models or the measurement model for performing the at least one measurement procedure comprises obtaining one or more measurement samples on one or more signals transmitted between the UE and a network node, wherein the one or more measurement samples do not result from using the selected one of the at least two AI/ML models or the measurement model.

10. (canceled)

11. The method of claim 1, wherein the UE, based on one of the first set of one or more criteria, selects one of the at least two AI/ML models based on how robust each model is.

12. The method of claim 11, wherein robust means that a model is trained for at least one of: a large radio environment; a large set of different cells; a large set of different geographical areas; a large range of signal quality values; a large range of channel delay spread values; a large range of time-of arrival values.

13. The method of claim 11, wherein robust means that a model is trained for at least one of: a challenging radio environment; a low radio signal coverage area; an indoor scenario; a high mobility UE.

14-18. (canceled)

19. The method of claim 1, further comprising transmitting information related to the selection between the at least two AI/ML models and/or the information related to the selection between the at least one AI/ML model and the measurement model, to a network node.

20. A method performed by a network node for configuring a user equipment, UE, for using an Artificial Intelligence/Machine Learning, AI/ML, model, for one or more measurement procedures, the method comprising:
obtaining a first set of one or more criteria which can be used by the UE for selecting between at least two AI/ML models for performing for one or more measurement procedures; and
transmitting information about the obtained first set of one or more criteria to the UE.

21. The method of claim 20, further comprising;
obtaining a second set of one or more criteria, which can be used by the UE for selecting between at least one AI/ML model and a measurement model for performing at least one measurement procedure; and
transmitting information about the obtained second set of one or more criteria to the UE.

22. The method of claim 20, further comprising receiving results of the one or more measurements performed by the UE.

23. The method of claim 20, further comprising using the received results for performing one or more operational tasks, wherein the one or more operational tasks comprise at least one of: a scheduling task; a positioning task; a cell change task; a handover task.

24. (canceled)

25. The method of claim 20, further comprising receiving, from the UE, information related to the selection between the at least two AI/ML models and/or the information related to the selection between the at least one AI/ML model and the measurement model.

26. A user equipment, UE, for using an Artificial Intelligence/Machine Learning, AI/ML, model, for one or more measurement procedures, comprising:
processing circuitry configured to perform the method of claim 1; and
power supply circuitry configured to supply power to the processing circuitry.

27. A network node for configuring a user equipment, UE, for using an Artificial Intelligence/Machine Learning, AI/ML, model, for one or more measurement procedures, the network node comprising:
processing circuitry configured to perform the method of claim 20; and
power supply circuitry configured to supply power to the processing circuitry.
